(19) United States
(12) Patent Application Publication
(10) Pub. No.: US 2014/0046971 A1
(43) Pub. Date: Feb. 13, 2014

(54) TRANSLATION OF UNIVERSAL PLUG AND PLAY SEARCH CRITERIA

(71) Applicants: Kevin Zack Barefoot, Cicero, IN (US); Kerry Wayne Calvert, Indianapolis, IN (US)

(72) Inventors: Kevin Zack Barefoot, Cicero, IN (US); Kerry Wayne Calvert, Indianapolis, IN (US)

(73) Assignee: THOMSON LICENSING, Issy de Moulineaux (FR)

(21) Appl. No.: 14/006,354

(22) PCT Filed: Oct. 31, 2011
(86) PCT No.: PCT/US11/58521

§ 371 Date: Sep. 20, 2013

Related U.S. Application Data
(60) Provisional application No. 61/429,578, filed on Jan. 4, 2011.

(51) Int. Cl. G06F 17/30

(52) U.S. Cl. CPC G06F 17/30979
USPC 707/769

(57) ABSTRACT

A method, apparatus and system for parsing a UPnP search criteria and creating a search criteria structure that is understandable to any content provider/storage device include an apparatus for dividing a universal plug and play search criteria into elements, assigning at least one element a designation and providing information regarding the assigned designation and an order of the at least one element within the universal plug and play search criteria, the information to be used for searching content. The apparatus of the invention creates a list of structures for performing a search, each structure including a designation of at least one respective element and an order of the at least one respective element within the universal plug and play search criteria.

This application claims priority from U.S. Provisional Application No. 61/429,578 filed Jan. 4, 2011.

### FIELD OF THE INVENTION

The present invention generally relates to Universal Plug and Play (UPnP) search criteria and, more particularly, to a method, apparatus and system for parsing a UPnP search criteria to create generic search criteria.

### BACKGROUND OF THE INVENTION

Content can be stored on any number of different devices. Extracting such content from the different devices, however, can involve duplicate work as similar processes can be performed for each device. The most common solution to this problem is for an invoker to reparse and generate the UPnP search criteria based on the device that hosted the content. This solution, however, may not be applicable for all devices.

### SUMMARY OF THE INVENTION

Embodiments of the present invention address the deficiencies of the prior art by providing a method, apparatus and system for intelligently parsing a UPnP search criteria and creating a structure that is understandable to any content provider. In accordance with the concepts of the present invention, each content provider can deal with a resulting structure of the present invention rather than parsing the UPnP search criteria and generating a respective, unique search statement.

In one embodiment of the present invention a method for parsing a UPnP search criteria to create generic search criteria includes dividing a universal plug and play search criteria into elements, assigning at least one element a designation and providing information regarding the assigned designation and an order of the at least one element within the universal plug and play search criteria, the information to be used for searching content.

In an alternate embodiment of the present invention, an apparatus for parsing a UPnP search criteria to create generic search criteria includes a memory for storing program routines and data and a processor for executing the program routines, the processor, when executing the program routines, configured to perform the steps of dividing a universal plug and play search criteria into elements, assigning at least one element a designation and providing information regarding the assigned designation and an order of the at least one element within the universal plug and play search criteria, the information to be used for searching content.

In an alternate embodiment of the present invention, a system for searching for content includes at least two content storage devices for storing content and a tokenizer including a memory for storing program routines and data and a processor for executing the program routines, the processor, when executing the program routines, configured to perform the steps of dividing a universal plug and play search criteria into elements, assigning at least one element a designation and providing information regarding the assigned designation and an order of the at least one element within the universal plug and play search criteria to the at least two content storage devices, the information to be used for searching content.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a system for parsing a UPnP search criteria and creating a search criteria structure that is understandable to a content provider in accordance with an embodiment of the present invention;

FIG. 2 depicts a high level block diagram of an apparatus suitable for application in the system of FIG. 1 for parsing a UPnP search criteria and creating a search criteria structure that is understandable to a content provider in accordance with an embodiment of the present invention; and

FIG. 3 depicts a flow diagram of a method for parsing a UPnP search criteria and creating a universal search criteria that is understandable to any content provider for performing a search in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for parsing a UPnP search criteria and creating a search criteria structure that is understandable to a content provider. Although the present invention will be described primarily within the context of a content management system, the specific embodiments of the present invention should not be treated as limiting the scope of the invention. It will be appreciated by those skilled in the art and informed by the teachings of the present invention that the concepts of the present invention can be advantageously applied in any commercial or residential environment for managing content.

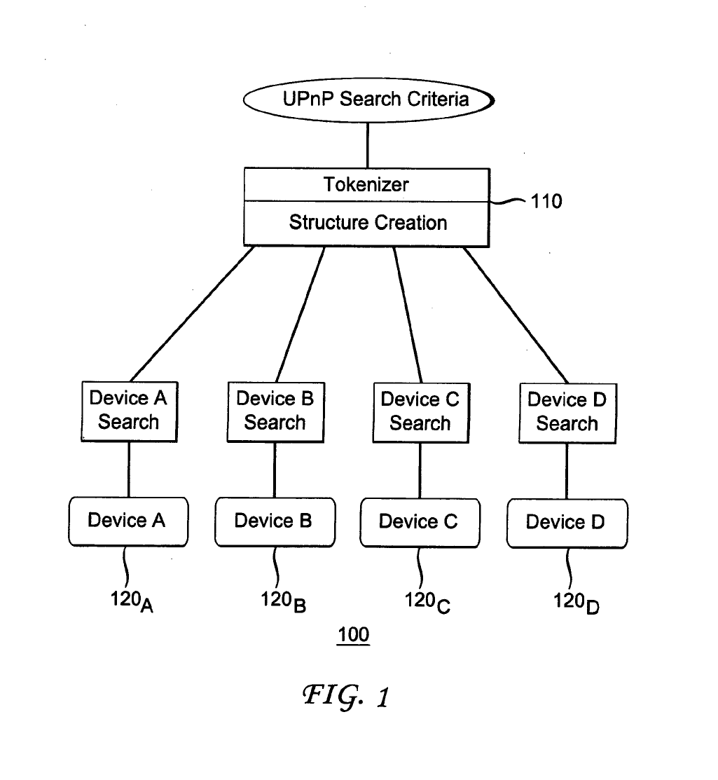

FIG. 1 depicts a high level block diagram of a system for parsing a UPnP search criteria and creating a search criteria structure that is understandable to a content provider in accordance with an embodiment of the present invention. The system 100 of FIG. 1 illustratively comprises a tokenizer/structure creator 110 and a plurality of content storage/providing devices 120_{A}, 120_{B}, 120_{C}, 120_{D} (illustratively four devices). In the system 100 of FIG. 1, the tokenizer/structure creator 110 receives and parses the UPnP search criteria.

That is, in accordance with various embodiments of the present invention, the parsing of the UPnP search criteria is based on preserving the order of operations while identifying each element of the string. This occurs as a parsing method/algorithm maintains proper spacing within any quoted criteria and escape characters. In one embodiment of the present invention, during this process each element is extracted as it is parsed and compared to a list of keywords defined in the Service Template Version 1.01 document that defines correct UPnP search usage. That is, in an embodiment of the present invention, each element is compared to a list of keywords that defines correct universal plug and play search usage to ensure that each element comprises a proper search term.

In an exemplary embodiment of the present invention in which the tokenizer/structure creator 110 of the present invention receives a UPnP search criteria of ‘(upnp:actor=“Harrison Ford)”, the tokenizer/structure creator 110 of the present invention divides the search criteria into five (5) separate elements as follows:

1) ‘(‘
2) upnp:actor
3) ‘=’
4) “Harrison Ford”
5) ‘)’

In the embodiment of the invention described above, each element is run through a filter which assigns each element a designation. In one embodiment of the present invention, a designation is assigned by encapsulating the element in quotes, which ensures that the element is identified as a literal element. As such, the element must be identified literally (i.e., exactly) in a search. That is, in such an embodiment a search is performed by searching for the exact element in the searched content and, as described above, an order of the element within the universal plug and play search criteria is also preserved in the search. As also described above, in an alternate embodiment of the present invention prior to performing a search, each element is compared to a list of keywords that defines correct universal plug and play search usage to ensure that each element comprises a proper search term.

In one embodiment of the present invention, the tokenizer/structure creator 110 of the present invention creates a list of structures for performing a search using structures, each structure including at least the designation of the elements and an order of the elements within the UPnP search criteria. For example, in the embodiment of the system 100 of FIG. 1, the tokenizer/structure creator 110 receives the UPnP search criteria, parses the search criteria to assign each element a designation and creates a list of structures, each one containing a key element, its order with the UPnP search criteria, and it's definition as it pertains to the Service Template Document. The list of structures is then implemented to search the plurality of content storage/providing devices 120_{A}, 120_{B}, 120_{D}, 120_{D} for content identified in the newly created search structure/criteria. That is, in such an embodiment of the present invention, a list of structures, each one containing a key element, its order with the UPnP search criteria, and its definition as it pertains to the Service Template Document is created and returned back to an invoker. This list of structures can then be easily read and translated for use in whatever device is storing the media to perform a search. In an alternate embodiment of the present invention, an element is considered equal to a logOp, relOp, or StringOp (Note: logOp, relOp, and StringOp are all defined on pg 57 of the Service Template Version 1.01 document). More specifically, in an alternate embodiment of the present invention, a designation is assigned for the elements by considering an element equal to a logOp, relOp, or StringOp (Note: logOp, relOp, and StringOp are all defined on pg 57 of the Service Template Version 1.01 document). As such, in such an embodiment a search is performed by searching for the logOp, relOp, or StringOp of an element in the searched content and, as described above, an order of the element within the universal plug and play search criteria is also preserved in the search. In yet an alternate embodiment of the present invention, an element is not encapsulated in quotes nor is it identified as a logOp, StringOp, or relOp. In such an embodiment, the element is considered an Element_Name like “upnp:actor” or “dc:title” as defined, in one embodiment, in the Service Template Version 1.01 document. As such, in such an embodiment a search is performed by searching for the content that matches the element name. As described above, an order of the element within the universal plug and play search criteria is also preserved in the search.

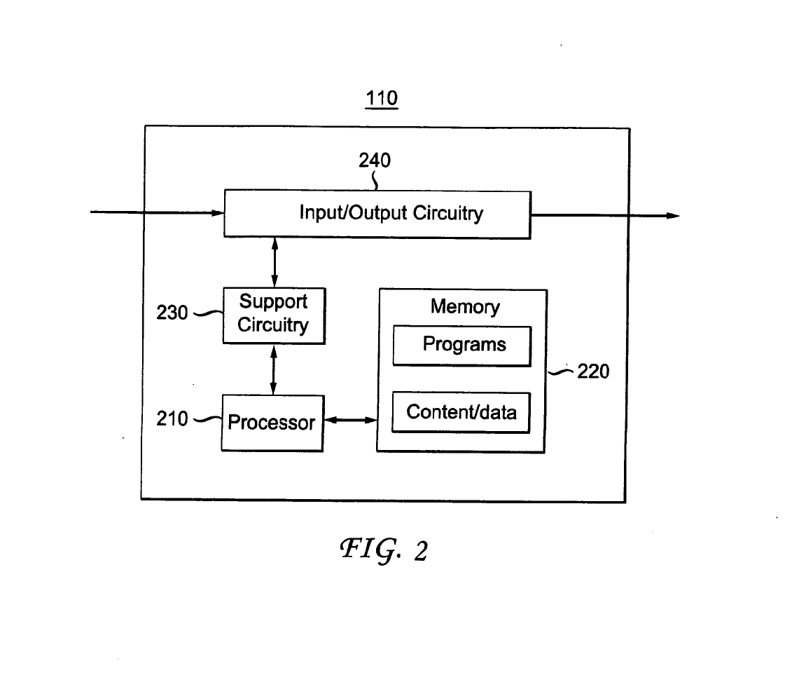

FIG. 2 depicts a high level block diagram of tokenizer/structure creator 110 suitable for application in the system of FIG. 1 for parsing a UPnP search criteria and creating a search criteria structure that is understandable to a content provider in accordance with an embodiment of the present invention. More specifically, the tokenizer/structure creator 110 of FIG. 2 illustratively comprises a processor 210 as well as a memory 220 for storing control programs, file information, stored content and the like. The tokenizer/structure creator 110 cooperates with conventional support circuitry 230 such as power supplies, clock circuits, cache memory and the like as well as circuits that assist in executing the software routines stored in the memory 220. As such, it is contemplated that some of the process steps discussed herein as software processes may be implemented within hardware, for example, as circuitry that cooperates with the tokenizer/structure creator 110 to perform various steps. The tokenizer/structure creator 110 also contains input-output circuitry 240 that forms an interface between various functional elements communicating with the tokenizer/structure creator 110 such as a set-top box, a network switch and the like.

Again, although the tokenizer/structure creator 110 of FIG. 2 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

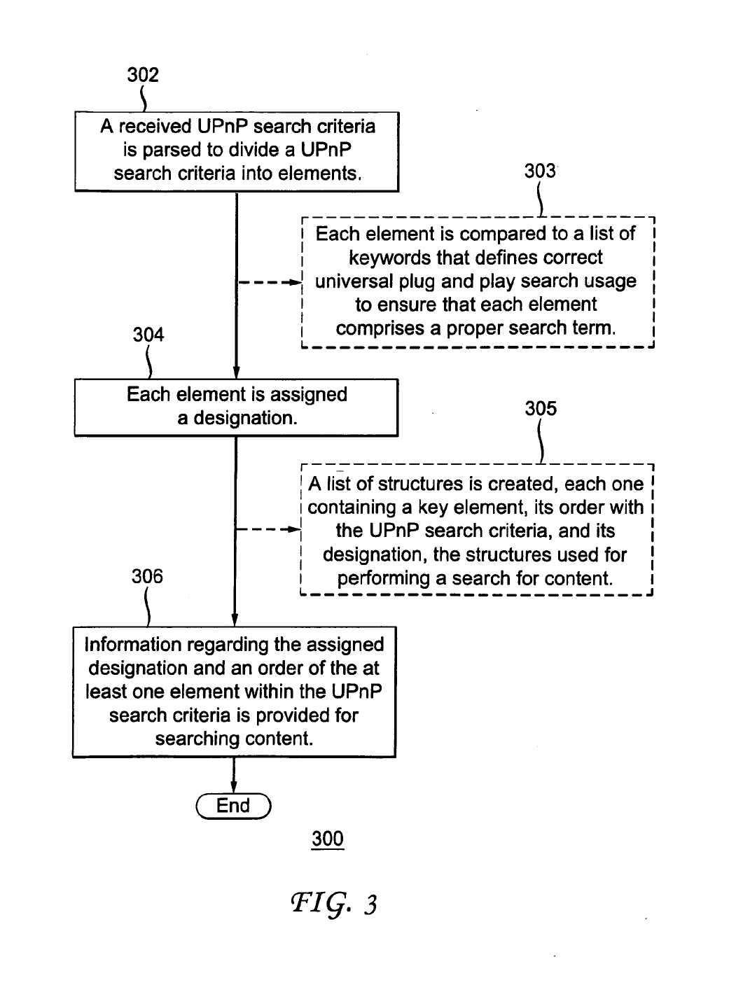

FIG. 3 depicts a flow diagram of a method for parsing UPnP search criteria and creating a search criteria structure that is understandable to any content provider to search for content in accordance with an embodiment of the present invention. The method 300 begins at step 302 during which a received UPnP search criteria is parsed to divide a UPnP search criteria into elements. The method 300 then proceeds to step 304.

At step 304, each element of the divided search criteria is assigned a designation in accordance with at least one of the embodiments described above. The method 300 then proceeds to step 306.

At step 306, information regarding the assigned designation and an order of the at least one element within the universal plug and play search criteria is provided to, for example an invoker of the search, the information to be used for searching content. The method 300 can then be exited.

Optionally, at step 303 (dotted lines), each element is compared to a list of keywords that defines correct universal plug and play search usage to ensure that each element comprises a proper search term.

In addition, optionally, at step 305 (dotted lines), a list of structures is created, each one containing a key element, its order with the UPnP search criteria, and its designation, which in one described embodiment can include a definition of the element as it pertains to the Service Template Document. Such a list of structures can then be communicated to an invoker of a search for performing a search for content.

Having described various embodiments for a method, apparatus and system for parsing a UPnP search criteria and creating a search criteria structure that is understandable to a content provider (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method, comprising:
dividing a universal plug and play search criteria into elements;
assigning at least one element a designation; and
providing information regarding the assigned designation and an order of the at least one element within the universal plug and play search criteria, the information to be used for searching content.

2. The method of claim 1, further comprising comparing each element to a list of keywords that defines correct universal plug and play search usage to ensure that each element comprises a proper search term.

3. The method of claim 1, further comprising creating a list of structures for performing a search, each structure including the designation of at least one respective element and an order of the at least one respective element within the universal plug and play search criteria.

4. The method of claim 1, wherein assigning each element a designation comprises encapsulating the at least one element in quotes such that the at least one element is identified as a literal element in a search.

5. The method of claim 1, wherein assigning each element a designation comprises defining the at least one element as at least one a logOp, relOp, and StringOp of the at least one element as defined in the Service Template Version 1.01 document of the UPnP forum.

6. The method of claim 1, wherein assigning each element a designation comprises defining the at least one element as an element name as defined in the Service Template Version 1.01 document of the UPnP forum.

7. The method of claim 6, wherein said element name comprises at least one of upnp:actor and dc:title as defined in the Service Template Version 1.01 document of the UPnP forum.

8. The method of claim 1, further comprising searching content using the assigned designation and an order of the at least one element within the universal plug and play search criteria.

9. An apparatus comprising:
a memory for storing program routines and data; and
a processor for executing said program routines, said processor, when executing said program routines, configured to perform the steps of:
dividing a universal plug and play search criteria into elements;
assigning at least one element a designation; and
providing information regarding the assigned designation and an order of the at least one element within the universal plug and play search criteria, the information to be used for searching content.

10. The apparatus of claim 9, wherein said apparatus creates a list of structures for performing a search, each structure including the designation of at least one respective element and an order of the at least one respective element within the universal plug and play search criteria.

11. The apparatus of claim 9, wherein said structure is used in a content storage device for searching content.

12. An apparatus comprising:
a content storage device for storing content, wherein said content storage device receives information regarding an assigned designation and an order of at least one element within a universal plug and play search criteria and uses the information to search the stored content.

13. A system for searching for content, comprising:
at least two content storage devices for storing content; and
a tokenizer including a memory for storing program routines and data and a processor for executing said program routines, said processor, when executing said program routines, configured to perform the steps of:
dividing a universal plug and play search criteria into elements;
assigning at least one element a designation; and
providing information regarding the assigned designation and an order of the at least one element within the universal plug and play search criteria to the at least two content storage devices, the information to be used for searching content.

14. The system of claim 13, wherein, by the dividing and assigning steps, said tokenizer generalizes said universal plug and play search criteria such that any of said at least two content storage devices can understand and process a search initiated by said divided and designated universal plug and play search criteria.

15. Computer-readable storage medium having a program recorded thereon; where the program enables the computer to execute the steps of:
dividing a universal plug and play search criteria into elements;
assigning at least one element a designation; and
providing information regarding the assigned designation and an order of the at least one element within the universal plug and play search criteria, the information to be used for searching content.
